(19) United States
(12) Patent Application Publication
(10) Pub. No.: US 2026/0361353 A1
(43) Pub. Date: Nov. 12, 2026

(54) WIRELESS TRANSMISSION DEVICE AND WIRELESS DISPLAY SYSTEM

(71) Applicant: LG ELECTRONICS INC., Seoul (KR)

(72) Inventor: Maengsob JI, Seoul (KR)

(73) Assignee: LG ELECTRONICS INC., Seoul (KR)

(21) Appl. No.: 19/131,891

(22) PCT Filed: Dec. 8, 2022
(86) PCT No.: PCT/KR2022/019952

§ 371 Date: May 21, 2025

(51) Int. Cl. H04B 7/06; H04B 17/23

(52) U.S. Cl. CPC H04B 7/0617; H04B 7/06952; H04B 17/23

(57) ABSTRACT

The present disclosure relates to enabling of intuitive guiding of a pointing correction operation of an antenna. A wireless transmission device according to an embodiment of the present disclosure may: obtain a beam identifier of a unit coverage area having the highest quality value among a plurality of unit coverage areas as a first optimal beam identifier (ID); and when it is determined that the first optimal beam ID is not the same as a preconfigured first target beam ID, generate a first antenna pointing correction guide for pointing correction of a plurality of transmission antennas.

### TECHNICAL FIELD

The present disclosure relates to a wireless display system that wirelessly transmits and receives A/V data.

### BACKGROUND ART

The wireless display system provides a TV service in which an A/V transmission device transmits a compressed A/V (Audio/Video) signal to an A/V reception device via a wireless connection, and the A/V reception device restores the compressed A/V signal and outputs it.

In the case of a wireless display system, RF (Radio Frequency) communication is performed between the A/V transmission device and the A/V reception device via antennas, so the arrangement position relationship between the sending antennas and the reception antennas is important for wireless quality.

Previously, users could roughly check the connection quality by checking the LED color or signal strength when adjusting the pointing (panning/tilting) of the antenna according to the arrangement conditions of the transmitting and reception antennas.

However, although beam tracking (horizontal/vertical) is possible through the beam forming of the antenna itself, there is a problem that the optimal antenna arrangement is not achieved compared to the beam setting that optimizes the performance of the antenna.

In addition, there was the inconvenience of having to repeat the Trial and Error task to check pointing for antenna arrangement.

### DISCLOSURE

### Technical Problem

An object of the present disclosure is to derive an optimal arrangement of sending antennas and reception antennas in a wireless display system.

An object of the present disclosure is to guide and enable a user to set the optimal antenna settings (Panning/Tilting) when transmitting and reception antennas are randomly arranged according to the installation environment and scenario in a space in a wireless display system.

### Technical Solution

A wireless transmission device according to an embodiment of the present disclosure may obtain a first optimal beam identifier (ID) as a beam identifier of a unit coverage area having a highest quality value among a plurality of unit coverage areas, and, if determining that the first optimal beam ID is not the same as the preset first target beam ID, generate a first antenna pointing correction guide for pointing correction of the plurality of transmission antennas.

A wireless display system according to an embodiment of the present disclosure includes a plurality of sending antennas, a wireless transmission device transmitting the compressed video data to a wireless reception device, and a wireless reception device receiving the compressed video data, restoring the received video data, and displaying the restored video data, and

the wireless transmission device may obtain a first optimal beam identifier (ID) as a beam identifier of a unit coverage area having a highest quality value among a plurality of unit coverage areas, and, if determining that the first optimal beam ID is not the same as the preset first target beam ID, may generate a first antenna pointing correction guide for pointing correction of the plurality of transmission antennas.

### Advantageous Effect

According to an embodiment of the present disclosure, when performing antenna pointing work, transmission and reception quality can be improved by setting an optimal antenna pointing setting rather than a rough arrangement setting using LEDs or the like.

In addition, according to the embodiment of the present disclosure, the user can perform intuitive and convenient settings according to the given guide when setting up the antenna.

In addition, cost savings can be achieved by making unnecessary components such as LEDs, which are means of indicating signal strength when setting antenna pointing.

### DESCRIPTION OF DRAWINGS

FIGS. 1 and 2 are views explaining the configuration of a display system according to one embodiment of the present disclosure.

FIG. 3 is a block diagram illustrating the configuration of a remote control device according to an embodiment of the present disclosure.

FIG. 4 is a flowchart for explaining a method for operating a wireless transmission device according to an embodiment of the present disclosure.

FIG. 5a is a view for explaining a first antenna beam book according to one embodiment of the present disclosure.

FIG. 5b is a view illustrating a process for generating information about a horizontal correction angle and information about a vertical correction angle according to one embodiment of the present disclosure.

FIGS. 6a and 6b are views illustrating a configuration for receiving pointing correction input according to an embodiment of the present disclosure.

FIGS. 7a and 7b are views illustrating a first antenna pointing correction guide according to an embodiment of the present disclosure.

FIG. 8a is a view for explaining a second antenna beam book according to one embodiment of the present disclosure.

FIG. 8b is a view illustrating a process for generating information about a horizontal correction angle and information about a vertical correction angle for precise antenna pointing.

FIGS. 9a and 9b are views illustrating a second antenna pointing correction guide according to an embodiment of the present disclosure.

FIGS. 10a and 10b are views illustrating an antenna pointing correction guide according to another embodiment of the present disclosure.

FIGS. 11a and 11b are views explaining examples of guiding the positions of the horizontal rotation direction of the rotation fan and the vertical movement direction of the lever, respectively.

FIGS. 12a and 12b are views explaining another example of guiding the positions of the horizontal rotation direction of the rotation fan and the vertical movement direction of the lever, respectively.

FIG. 13 is a view explaining the process of selecting an optimal beam ID when the communication quality between an A/V transmission device and an AV reception device is unstable.

FIG. 14 is a view illustrating a guide image provided when no valid link is found according to an embodiment of the present disclosure.

FIG. 15 is a drawing illustrating a sending antenna beam book and a reception antenna beam book according to an embodiment of the present disclosure.

### BEST MODEL

An audio/video (hereinafter, A/V) transmission device according to an embodiment of the present disclosure is, for example, an intelligent device that adds a computer-assisted function to a broadcast reception function, and while remaining faithful to the broadcast reception function, an Internet function and the like are added, and a more convenient interface such as a manual input device, a touch screen, or a space remote control can be provided.

In addition, with the support of wired or wireless Internet functions, it is possible to connect to the Internet and a computer, and perform functions such as email, web browsing, banking, or games. A standardized general-purpose OS can be used for these various functions.

Accordingly, the A/V transmission device described in the present disclosure can perform various user-friendly functions since various applications can be freely added or deleted, for example, on a general-purpose OS kernel.

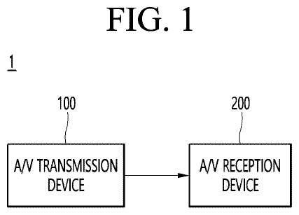

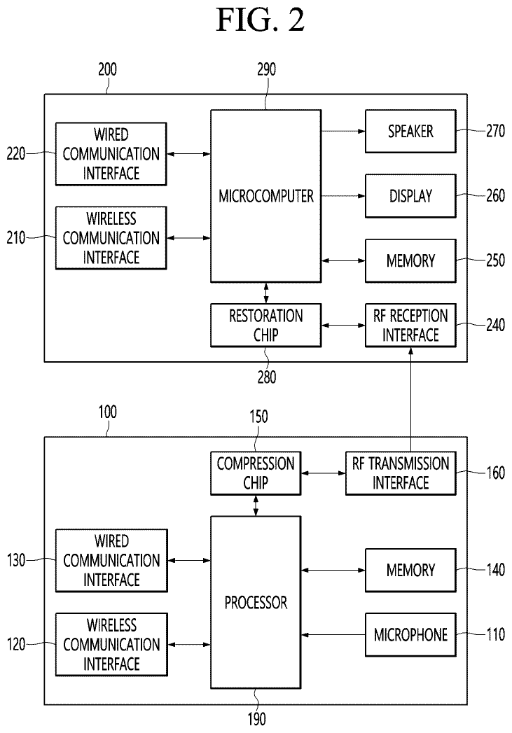

FIGS. 1 and 2 are views explaining the configuration of a display system according to one embodiment of the present disclosure.

Referring to FIG. 1, a wireless display system 1 according to one embodiment of the present disclosure includes an A/V transmission device 100 and an A/V reception device 200.

A wireless display system 1 may be a system in which an A/V transmission device 100 wirelessly transmits A/V data to an A/V reception device 200, and the A/V reception device 200 outputs A/V data.

The A/V transmission device 100 may be a device capable of encoding video and audio and wirelessly transmitting encoded content video and audio.

The A/V transmission device 100 may be a set-top box.

The A/V transmission device 100 can be connected to an external device such as a set-top box or a USB memory. The A/V transmission device 100 can transmit a video signal or audio signal received from the connected external device to the A/V reception device 200.

The A/V reception device 200 may be a display device capable of wirelessly receiving encoded video and audio and decoding the received video and audio.

An A/V transmission device 100 and an A/V reception device 200 can constitute a video wall display system.

In a video wall, having a display with a thin bezel plays an important role in visualizing content videos. In order to have a thin bezel on the display, it is efficient to have only the components that can play a minimal role, and to have the circuits or components for the main function performed in a separate device.

The A/V transmission device 100 can determine the type of content video input from the outside and, based on the determined type, determine the compression ratio of the content video. The compression ratio of the content video can be defined as the ratio of the size of the video data before encoding and the size of the video data after encoding.

The type of content video can include still image type, general video type, and game video type.

An A/V transmission device 100 can compress a content video according to a determined compression ratio and wirelessly transmit the compressed content video to an A/V reception device 200.

The A/V reception device 200 can restore a compressed content video received from the A/V transmission device 100 and display the restored content video on a display.

FIG. 2 is a block diagram illustrating the detailed configuration of an A/V transmission device 100 and an A/V reception device 200.

Referring to FIG. 2, the A/V transmission device 100 may include a microphone 110, a wireless communication interface 120, a wired communication interface 130, a memory 140, a compression chip 150, an RF transmission interface 160, and a processor 190.

The microphone 110 can receive an audio signal and transmit it to a processor 190.

The microphone 110 can receive a voice spoken by a user.

The wireless communication interface 120 may include one or more of a WiFi module and a Bluetooth module.

The Wi-Fi module can perform wireless communication with an external device or A/V reception device 200 through the Wi-Fi standard.

The Bluetooth module can perform wireless communication through the Bluetooth Low Energy (BLE) standard.

The Bluetooth module can perform wireless communication with an external device such as a remote control or an A/V reception device 200 through the Bluetooth Low Energy (BLE) standard.

The wireless communication interface 120 may also have a tuner for receiving broadcast signals.

The wired communication interface 130 may be an interface for wired connection with an external device. The wired communication interface 130 may include a plurality of HDMI (High Definition Multimedia Interface) terminals or USB (Universal Serial Bus) ports.

The wired communication interface 130 can receive a video signal or audio signal from an external device.

The memory 140 stores a program for signal processing and control, and can store signal-processed videos, voices, or data signals.

The memory 140 may perform a function for temporary storage of videos, voices, or data signals input from the outside, and may also store information about a specific image through a channel memory function.

The compression chip 150 can compress a video signal or audio signal input from the outside and transmit the compressed signal to the RF transmission interface 160.

The compression chip 150 may be equipped with an encoder for compressing a video signal or an audio signal.

The RF transmission interface 160 can transmit an A/V signal to the RF reception interface 240 of the A/V reception device 200 via RF (Radio Frequency) communication.

The RF transmission interface 160 may include one or more antennas.

The RF transmission interface 160 can transmit a compressed A/V signal in digital form to the RF reception interface 240.

The RF transmission interface 160 can transmit A/V signals to the RF reception interface 240 via one or more channels.

The processor 190 can control the overall operation of the A/V transmission device 100. The processor 190 can be referred to as a main system on chip (Main SoC).

The processor 190 may also include a compression chip 150.

The A/V reception device 200 may include a wireless communication interface 210, a wired communication interface 220, an RF reception interface 240, a memory 250, a display 260, a speaker 270, a restoration chip 280, and a microcomputer 290.

The wireless communication interface 210 may include a WiFi module, a Bluetooth module, and an IR module.

The WiFi module can perform wireless communication through the WiFi standard.

The Wi-Fi module can perform wireless communication with an external device or A/V transmission device 100 through the Wi-Fi standard.

The Bluetooth module can perform wireless communication through the Bluetooth Low Energy (BLE) standard.

The Bluetooth module can perform wireless communication with an external device such as a remote control or an A/V transmission device 100 through the Bluetooth Low Energy (BLE) standard.

The IR module can receive signals from a remote control 300 to be described later via IR (Infrared) communication.

The wired communication interface 220 may be an interface for wired connection with an external device. The wired communication interface 220 may include a plurality of HDMI (High Definition Multimedia Interface) terminals or USB (Universal Serial Bus) ports.

The wired communication interface 220 can receive a video signal or audio signal from an external device.

The RF reception interface 240 can receive a compressed A/V signal from the RF transmission interface 160.

The RF reception interface 240 may include multiple antennas. The RF reception interface 240 may be positioned at the lower end of the display 260.

The RF reception interface 240 may include a first antenna module and a second antenna module. The first antenna module and the second antenna module may each include a plurality of antennas.

The RF reception interface 240 can receive a compressed A/V signal in digital form from the RF transmission interface 160 and transmit the received A/V signal to the restoration chip 280.

The memory 250 stores a program for signal processing and control, and can store signal-processed images, voices, or data signals.

The display 260 can display a video signal received from the microcomputer 290.

The display 260 can display a video signal according to the operation of a timing controller (not illustrated).

The restoration chip 280 can restore the compressed A/V signal received by the RF reception interface 240. To this end, the restoration chip 280 can include a decoder.

The microcomputer 290 can control the overall operation of the A/V reception device 200.

The microcomputer 290 can output a restored video signal through a display 260 and output a restored audio signal through a speaker 270.

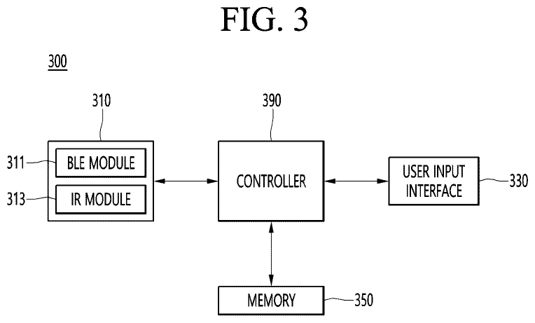

FIG. 3 is a block diagram illustrating the configuration of a remote control device according to an embodiment of the present disclosure.

Referring to FIG. 3, the remote control device 300 may include a wireless communication interface 310, a user input interface 330, a memory 350, and a controller 390.

The wireless communication interface 310 may be an interface for performing wireless communication with an A/V transmission device 100 or an A/V reception device 200.

The wireless communication interface 310 may include a Bluetooth Low Energy (BLE) module 311 and an IR (InfraRed) module 313.

The BLE module 311 can transmit a signal to the A/V transmission device 100 to control the operation of the A/V transmission device 100.

The BLE module 311 can transmit a signal to the A/V transmission device 100 that triggers a pairing operation of the A/V transmission device 100.

The user input interface 330 may consist of a keypad, a button, a touch pad, or a touch screen.

The user input interface 330 can generate control commands to control the operation of the A/V transmission device 100 or the A/V reception device 200 according to the user's operating commands.

When the user input interface 330 has a hard key button, the user can operate the hard key by pushing the hard key button.

The user input interface 330 may be equipped with various types of input means that can be operated by the user, such as a scroll key and a jog key.

The memory 350 can store a program for the operation of the controller 390 and can also temporarily store input/output data.

The controller 390 controls operations related to the application and, typically, the overall operation of the remote control device 300.

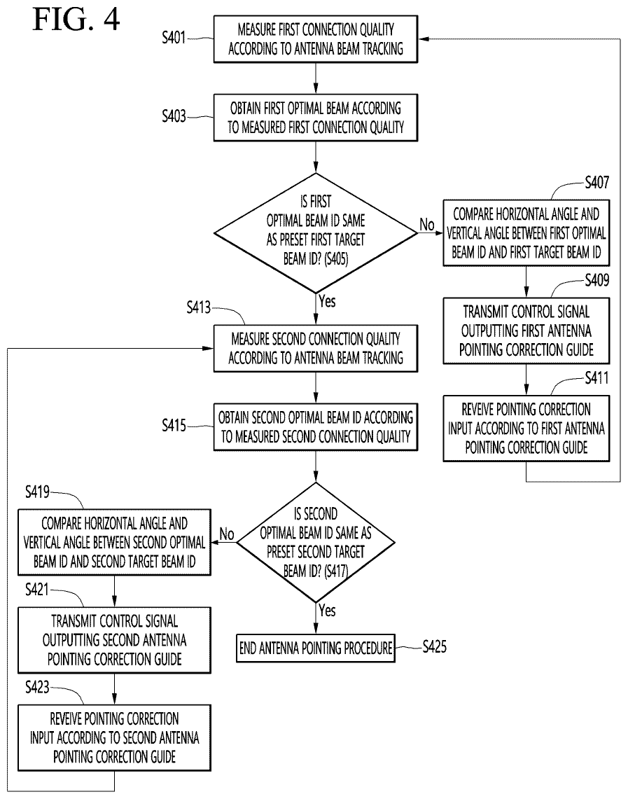

FIG. 4 is a flowchart for explaining a method for operating a wireless transmission device according to an embodiment of the present disclosure.

Referring to FIG. 4, the processor 190 of the A/V transmission device 100 measures the first connection quality indicating the communication quality with the A/V reception device 200 according to antenna beam tracking (S401).

The processor 190 can control the plurality of sending antennas included in the RF transmission interface 160 to sequentially output beams toward each of the plurality of angles. The beams can be radiated at an angle in a horizontal direction and at ab angle in a vertical direction.

The first connection quality can be measured by one or more of the Received Signal Strength Indicator (RSSI) and the Signal-to-Noise Ratio (SNR).

The microcomputer 290 of the A/V reception device 200 can measure one or more of RSSI or SNR based on beams received from the sending antennas, and can transmit one or more of the measured RSSI or SNR to the wireless communication interface 120 of the A/V transmission device 100 through the wireless communication interface 210.

In another embodiment, the processor 190 of the A/V transmission device 100 may receive information about a beam from the A/V reception device 200 and directly measure one or more of the RSSI or SNR based on the received information about the beam.

The processor 190 can divide the entire coverage area from which beams of sending antennas are radiated into a plurality of unit coverage areas and sequentially radiate beams for each unit coverage area.

The processor 190 can measure a plurality of connection qualities corresponding to each of the plurality of unit coverage areas by tracking a beam radiated through each unit coverage area.

The processor 190 of the A/V transmission device 100 obtains a first optimal beam ID (Identifier) according to the measured first connection quality (S403).

The processor 190 can obtain a unit coverage area corresponding to the best quality (largest value) connection quality among a plurality of connection qualities corresponding to each of a plurality of unit coverage areas.

The processor 190 can determine the identifier of the acquired unit coverage area as the first optimal beam identifier.

The first optimal beam identifier can identify a unit coverage area having an optimal connection quality among a plurality of unit coverage areas into which the entire coverage area is divided.

The first optimal beam identifier can be expressed as letters or a combination of numbers and letters.

The processor 190 can determine a first optimal beam ID using a first antenna beam book containing information identifying a plurality of unit coverage areas.

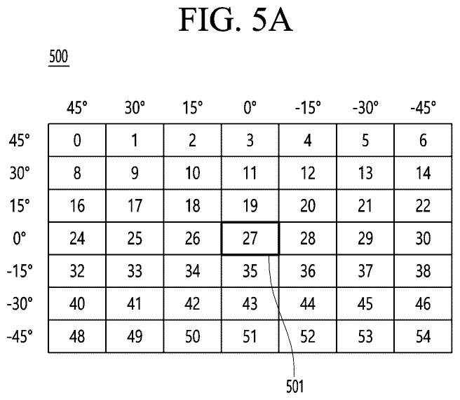

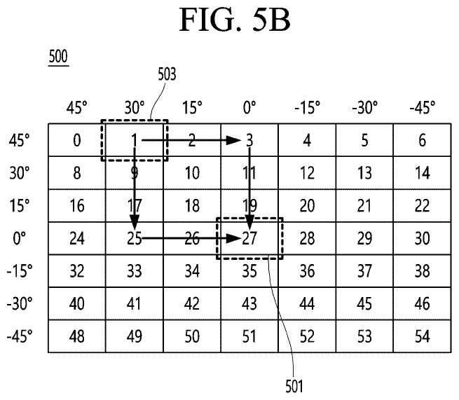

FIG. 5a is a view for explaining a first antenna beam book according to one embodiment of the present disclosure.

The first antenna beam book 500 may include information dividing the entire coverage area of a beam radiated through a plurality of sending antennas included in the RF transmission interface 160 into a plurality of unit coverage areas.

The first antenna beam book 500 may be stored in the memory 140 of the A/V transmission device 200.

The entire coverage area can be divided into 55 unit coverage areas, and each unit coverage area can be assigned a beam ID from 0 to 54.

The horizontal axis of the first antenna beam book 500 may represent the angle of the beam radiated in the horizontal direction, and the vertical axis thereof may represent the angle of the beam radiated in the vertical direction.

Each beam ID may be matched with any one horizontal angle in the range from −45 degrees to +45 degrees and any vertical angle in the range from −45 degrees to +45 degrees.

An angle in a horizontal direction and an angle in a vertical direction correspond to each other in each unit coverage area.

There can be a 15 degree gap between adjacent unit coverage areas on the horizontal axis, and a 15 degree gap between adjacent unit coverage areas on the vertical axis.

The processor 190 can measure connection quality values with the A/V reception device 200 using beams radiated through each of the plurality of unit coverage areas.

The processor 190 can obtain a beam ID corresponding to a unit coverage area having the largest connection quality value among a plurality of connection quality values as a first optimal beam ID.

Again, FIG. 4 is explained.

The processor 190 of the A/V transmission device 100 determines whether the first optimal beam ID matches the preset first target beam ID (S405).

In one embodiment, the first target beam ID may be an ID corresponding to a unit coverage area set as a default in advance, taking into account the performance of the sending antennas.

The performance of an antenna may include physical characteristics such as antenna gain and phase error.

For example, the first target beam ID may be 27 corresponding to the unit coverage area 501 in the first antenna beam book 500 of FIG. 5a.

If the processor 190 of the A/V transmission device 100 determines that the first optimal beam ID is not identical to the preset first target beam ID, it compares the horizontal angle and vertical angle between the first optimal beam ID and the first target beam ID (S407).

The processor 190 may compare the horizontal angle of the first optimal beam ID with the horizontal angle of the first target beam ID, and may compare the vertical angle of the first optimal beam ID with the vertical angle of the first target beam ID, if the first optimal beam ID is not the same as the preset first target beam ID.

The processor 190 of the A/V transmission device 100 transmits a control signal to the A/V reception device 200 to output a first antenna pointing correction guide based on the comparison result (S409).

The processor 190 can generate a horizontal correction angle and a vertical correction angle based on the comparison result of the first optimal beam ID and the first target beam ID.

The horizontal compensation angle may be an angle representing the difference between the horizontal angle of the first optimal beam ID and the horizontal angle of the first target beam ID.

The vertical compensation angle may be an angle representing the difference between the vertical angle of the first optimal beam ID and the vertical angle of the first target beam ID.

The processor 190 can generate a first antenna pointing correction guide including information about a horizontal correction angle and information about a vertical correction angle, and transmit a control signal including the generated first antenna pointing correction guide to an A/V reception device 200 through a wireless communication interface 120 or an RF transmission interface 160.

The first antenna pointing correction guide may include a guide image as described below.

The first antenna pointing correction guide may include first horizontal correction information including a horizontal correction angle and a rotation direction (or panning direction) of the horizontal correction angle, and second vertical correction information including a vertical correction angle and a tilting direction of the vertical correction angle.

The received first antenna pointing correction guide of the A/V reception device 200 can be displayed on the display 260.

FIG. 5b is a view illustrating a process for generating information about a horizontal correction angle and information about a vertical correction angle according to one embodiment of the present disclosure.

The processor 190 of the A/V transmission device 100 can obtain information on the horizontal correction angle and information on the vertical correction angle using the first antenna beam book 500.

It is assumed that the area corresponding to the first target beam ID (ID no. 27) is the first unit coverage area 501, and the area corresponding to the first optimal beam ID (ID no. 1) is the second unit coverage area 503.

The processor 190 can generate a first antenna correction guide to change the pointing direction (radiation direction) of the sending antennas from the second unit coverage area 503 to the first unit coverage area 501.

For example, the processor 190 may generate information about a horizontal correction angle indicating a 30 degree clockwise rotation (verify ID 3), and then generate information about a vertical correction angle indicating a 45 degree upward tilt.

As another example, the processor 190 may generate information about a vertical compensation angle that causes tilting by 45 degrees in an upward direction (check ID 25), and then generate information about a horizontal compensation angle that causes rotation by 30 degrees in a clockwise direction.

Again, FIG. 4 is explained.

The processor 190 of the A/V transmission device 100 receives a pointing correction input according to the first antenna pointing correction guide (S411) and performs step S401.

The pointing correction input may be an input for adjusting a rotation fan or lever provided in the A/V transmission device 100.

The user can perform pointing correction work of the sending antennas by adjusting the rotation fan or lever with reference to the first antenna pointing correction guide displayed on the A/V reception device 200. The A/V reception device 200 can display the operation result for the pointing correction input. The operation result can include information indicating the success or additional operation of the antenna pointing correction.

The processor 190 can repeatedly perform steps S401 to S411 until the first optimal beam ID is the same as the first target beam ID.

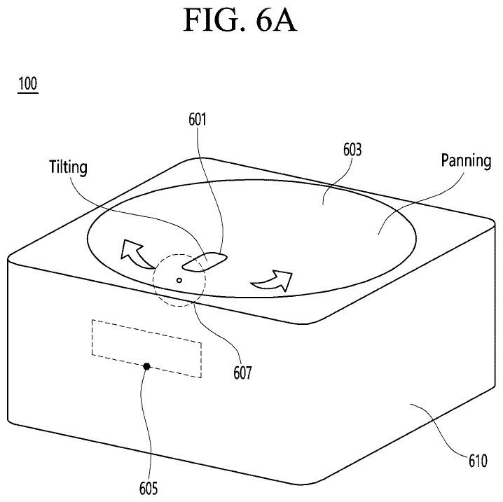

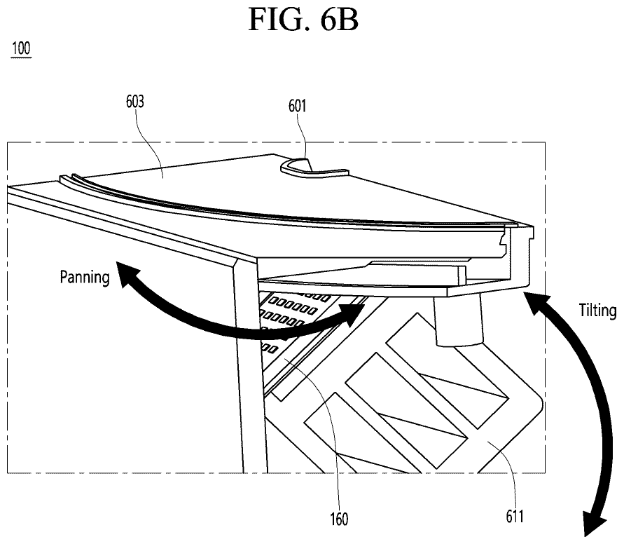

FIGS. 6a and 6b are views illustrating a configuration for receiving pointing correction input according to an embodiment of the present disclosure.

FIG. 6a is a perspective view of an A/V transmission device 100, and FIG. 6b is a view explaining the internal structure of the A/V transmission device 100.

Referring to FIG. 6a, the A/V transmission device 100 may include a box 610, a lever accommodation part 601 for accommodating a lever 601a, a rotation fan 603, a power status display part 605, and a communication quality status display part 607.

The interior of the box 610 may contain components of the A/V transmission device 100 described in FIG. 2.

The lever 601a may be a means for controlling the vertical direction (tilting control) of the RF transmission interface 160 illustrated in FIG. 6b.

The rotation fan 603 may be a means for controlling the horizontal rotation direction (panning control) of the RF transmission interface 160 illustrated in FIG. 6b.

The power status display part 605 can indicate the power on or off status of the A/V transmission device 100. The power status display part 605 can have one or more LEDs.

The communication quality status display part 607 can indicate the communication quality status between the A/V transmission device 100 and the A/V reception device 200. The communication quality status display part 607 can be equipped with one or more LEDs.

The communication quality status display part 607 is an optional configuration and may not be provided in the box 610.

The processor 190 can receive pointing correction input via a lever 601a or a rotation fan 603.

The processor 190 can tilt the RF transmission interface 160 including the sending antennas in the vertical direction according to the input of moving the lever 601a. The RF transmission interface 160 can include a substrate and a plurality of sending antennas. The RF transmission interface 160 can be provided on the upper end of a heat sink 611 that discharges heat generated inside the box 610.

The processor 190 can pan the RF transmission interface 160 including the sending antennas in the left and right direction according to an input that moves the rotation fan 603.

The user can perform antenna pointing correction work by operating the lever 601a or the rotation fan 603 while looking at the first antenna correction guide.

According to another embodiment of the present disclosure, a motor (not illustrated) for automatically controlling tilting of the RF transmission interface 160 according to information about the determined vertical correction angle and a motor (not illustrated) for automatically controlling panning of the RF transmission interface 160 according to information about the determined horizontal correction angle may be further provided in the box 610.

In this case, the RF transmission interface 120 can be set to have an optimal layout structure without a separate guide, thereby maximizing user convenience.

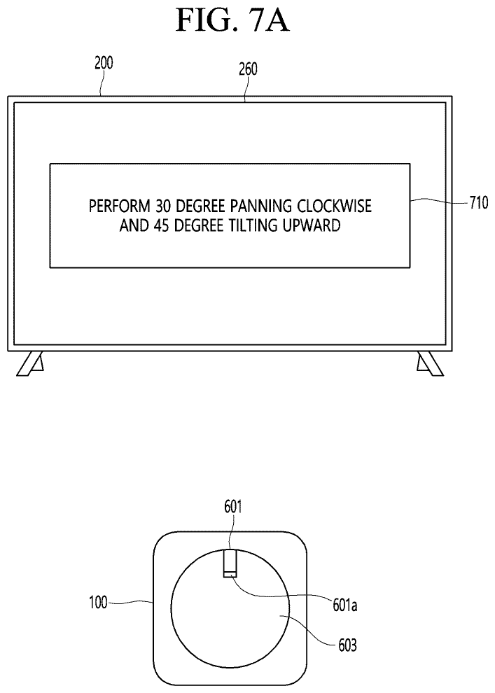

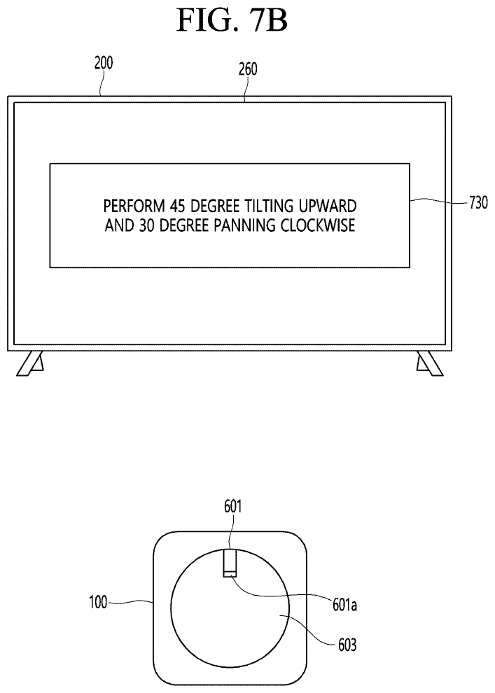

FIGS. 7a and 7b are views illustrating a first antenna pointing correction guide according to an embodiment of the present disclosure.

Referring to FIGS. 7a and 7b, an A/V transmission device 100 and an A/V reception device 200 are illustrated.

The A/V reception device 200 can display the first antenna pointing correction guide 710, 730 on the display 260 according to a control signal for outputting the first antenna pointing correction guide received from the A/V transmission device 100.

The first antenna pointing correction guide 710, 730 may include text guiding panning and tilting operations according to the embodiment of FIG. 5b.

The user can operate the lever 601a and the rotation fan 603 via the first antenna pointing correction guide 710, 730.

In this way, according to the embodiment of the present disclosure, the user can intuitively and conveniently set the antenna arrangement according to the given guide.

Again, FIG. 4 is explained.

After steps S401 to S411, steps S413 and thereafter may be performed, but these may be optional configurations.

Step S413 and subsequent steps are for more precise antenna pointing settings.

The processor 190 of the A/V transmission device 100 measures the second connection quality according to antenna beam tracking if determining that the first optimal beam ID is the same as the preset first target beam ID (S413).

The processor 190 can divide a unit coverage area corresponding to the first target beam ID into a plurality of sub-areas.

The processor 190 can control the plurality of transmission antennas included in the RF transmission interface 160 to sequentially output beams toward each of the plurality of angles included in the angular range of the unit coverage area.

The secondary connection quality may be measured by one or more of the Received Signal Strength Indicator (RSSI) and the Signal-to-Noise Ratio (SNR).

The microcomputer 290 of the A/V reception device 200 can measure one or more of RSSI or SNR based on beams received from the sending antennas, and can transmit one or more of the measured RSSI or SNR to the wireless communication interface 120 of the A/V transmission device 100 through the wireless communication interface 210.

In another embodiment, the processor 190 of the A/V transmission device 100 may receive information about a beam from the A/V reception device 200 and directly measure one or more of the RSSI or SNR based on the received information about the beam.

The processor 190 can divide a unit coverage area corresponding to the first target beam ID into a plurality of sub-areas and sequentially radiate a beam to each sub-area.

The processor 190 can measure a plurality of connection qualities corresponding to each of the plurality of sub-areas by tracking the beam radiated through each sub-area.

The processor 190 of the A/V transmission device 100 obtains a second optimal beam ID according to the measured second connection quality (S415).

The processor 190 can determine a sub-area corresponding to the best quality (largest value) connection quality among the plurality of connection qualities corresponding to each of the plurality of sub-areas.

The processor 190 can determine the identifier of the determined sub-area as a second optimal beam identifier (ID).

The second optimal beam identifier can identify a sub-area having an optimal connection quality among a plurality of sub-areas into which a unit coverage area corresponding to the first target beam ID is divided.

The second optimal beam identifier can be represented by a number, a letter, or a combination of numbers and letters.

The processor 190 can determine a second optimal beam ID using a second antenna beam book containing information identifying a plurality of unit coverage areas.

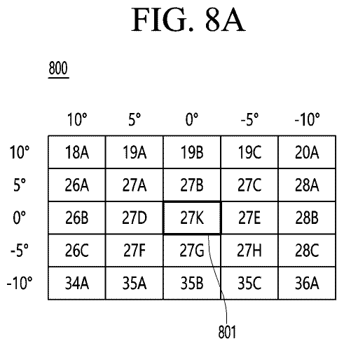

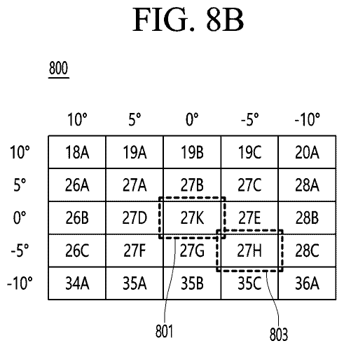

FIG. 8a is a view for explaining a second antenna beam book according to one embodiment of the present disclosure.

The second antenna beam book 800 may include information dividing the unit coverage area 501 corresponding to the first target beam ID (No. 27) illustrated in FIG. 5a into a plurality of sub-areas.

The second antenna beam book 800 may be stored in the memory 140 of the A/V transmission device 200.

A unit coverage area can be divided into 25 unit coverage areas, and each unit coverage area can be assigned a beam ID, which is a combination of numbers and letters.

The horizontal axis of the second antenna beam book 800 may represent the angle of the beam radiated in the horizontal direction, and the vertical axis may represent the angle of the beam radiated in the vertical direction.

Each beam ID may be matched with any one horizontal angle in the range from −10 degrees to +10 degrees and any vertical angle in the range from −10 degrees to +10 degrees.

There can be a 5 degree gap in the horizontal direction between adjacent sub-areas on the horizontal axis, and a 5 degree gap between adjacent sub-areas on the vertical axis.

The processor 190 can measure connection quality values with the A/V reception device 200 using beams radiated through each of the plurality of sub-areas constituting the second antenna beam book 800.

The processor 190 can obtain a beam ID corresponding to a unit coverage area having the largest connection quality value among a plurality of connection quality values as a second optimal beam ID.

The processor 190 of the A/V transmission device 100 determines whether the second optimal beam ID is the same as the preset second target beam ID (S417).

The second target beam ID may be an ID corresponding to a sub-area that is set as a default in advance, taking into account the performance of the sending antennas.

For example, the second target beam ID may be 27K corresponding to the sub-coverage area 801 in the second antenna beam book 800 of FIG. 8a.

If the processor 190 of the A/V transmission device 100 determines that the second optimal beam ID is not the same as the preset second target beam ID, the processor compares the horizontal angle and the vertical angle between the second optimal beam ID and the second target beam ID (S419).

The processor 190 may compare the horizontal angle of the second optimal beam ID with the horizontal angle of the second target beam ID, and may compare the vertical angle of the second optimal beam ID with the vertical angle of the second target beam ID, if the second optimal beam ID is not the same as the preset second target beam ID.

The processor 190 of the A/V transmission device 100 transmits a control signal to the A/V reception device 200 to output a second antenna pointing correction guide based on the comparison result (S421).

The processor 190 can generate a horizontal correction angle and a vertical correction angle based on the comparison result between the second optimal beam ID and the second target beam ID.

The horizontal compensation angle may be an angle representing the difference between the horizontal angle of the second optimal beam ID and the horizontal angle of the second target beam ID.

The vertical compensation angle may be an angle representing the difference between the vertical angle of the second optimal beam ID and the vertical angle of the second target beam ID.

The processor 190 can generate a second antenna pointing correction guide including information about a horizontal correction angle and information about a vertical correction angle, and transmit a control signal including the generated second antenna pointing correction guide to an A/V reception device 200 through a wireless communication interface 120 or an RF transmission interface 160.

The second antenna pointing correction guide may include second horizontal correction information including a horizontal correction angle and a rotation direction of the horizontal correction angle, and second vertical correction information including a vertical correction angle and a tilting direction of the vertical correction angle.

The second antenna pointing correction guide may include a guide image.

The received second antenna pointing correction guide of the A/V reception device 200 can be displayed on the display 260.

FIG. 8b is a view illustrating a process for generating information about a horizontal correction angle and information about a vertical correction angle for precise antenna pointing.

The processor 190 of the A/V transmission device 100 can obtain information on the horizontal correction angle and information on the vertical correction angle using the second antenna beam book 800.

It is assumed that the area corresponding to the second target beam ID (27K) is the first sub-area 801, and the area corresponding to the second optimal beam ID (27H ID) is the second sub-area 803.

The processor 190 can generate a second antenna correction guide to change the pointing direction (radiation direction) of the sending antennas from the second sub-area 803 to the first sub-area 801.

For example, the processor 190 may generate information about a horizontal compensation angle indicating a 5 degree counterclockwise rotation (verify 27G ID), and then generate information about a vertical compensation angle indicating a 5 degree downward tilt.

As another example, the processor 190 may generate information about a vertical compensation angle that causes tilting by 5 degrees in a downward direction (check 27E ID), and then generate information about a horizontal compensation angle that causes rotation by 5 degrees in a counterclockwise direction.

Again, FIG. 4 is explained.

The processor 190 of the A/V transmission device 100 receives a pointing correction input according to the second antenna pointing correction guide (S423) and performs step S413.

The pointing correction input may be an input for adjusting a rotation fan 603 or lever 601a provided in the A/V transmission device 100.

The user can perform precise pointing correction work of the sending antennas by adjusting the rotation fan 603 or lever 601a with reference to the second antenna pointing correction guide displayed on the A/V reception device 200.

The processor 190 can repeatedly perform steps S413 to S423 until the second optimal beam ID is the same as the second target beam ID.

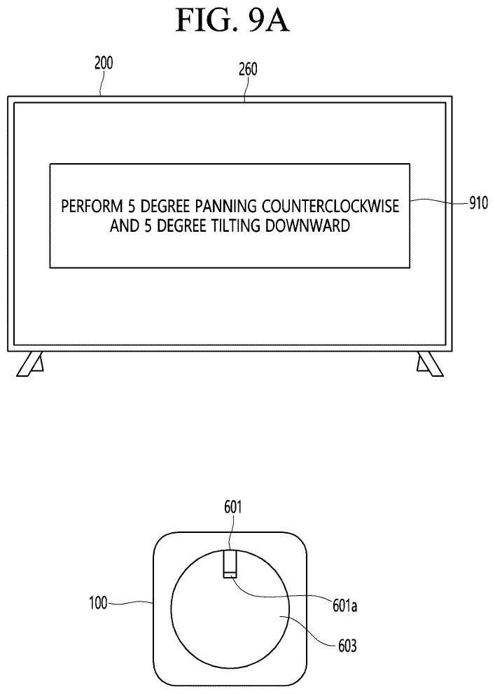

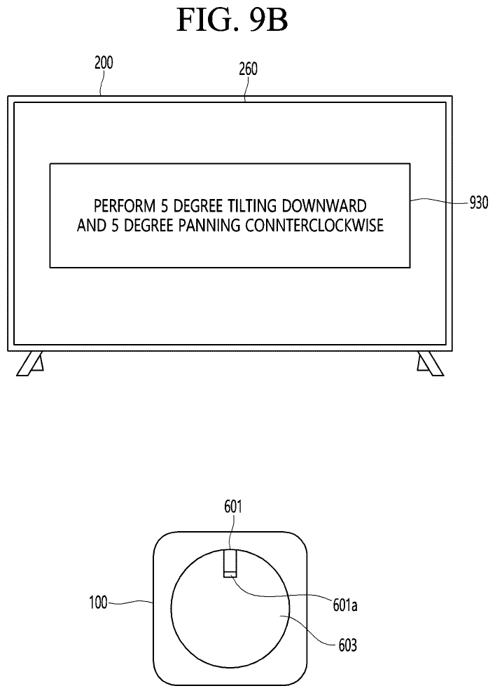

FIGS. 9a and 9b are views illustrating a second antenna pointing correction guide according to an embodiment of the present disclosure.

Referring to FIGS. 9a and 9b, an A/V transmission device 100 and an A/V reception device 200 are illustrated.

The A/V reception device 200 can display the second antenna pointing correction guide 910, 930 on the display 260 according to a control signal for outputting the second antenna pointing correction guide received from the A/V transmission device 100.

The first antenna pointing correction guide 710, 730 may include text guiding panning and tilting operations according to the embodiment of FIG. 5b.

The user can operate the lever 601a and the rotation fan 603 via the first antenna pointing correction guide 710, 730.

In this way, the user can perform more precise antenna pointing settings, so that the image can be transmitted to the receiving end with high quality and without delay.

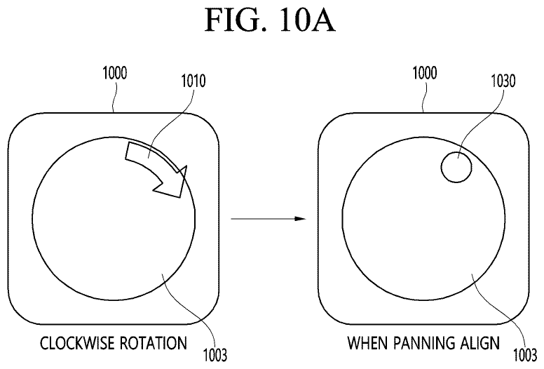

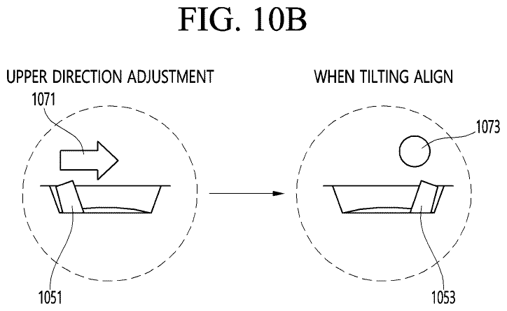

FIGS. 10a and 10b are views illustrating an antenna pointing correction guide according to another embodiment of the present disclosure.

Each guide image to be described below can be generated based on a control signal received from an A/V transmission device 100. The guide image can be generated by the A/V transmission device 100 or the A/V reception device 200.

FIGS. 10a and 10b are views explaining an example of guiding the horizontal rotation direction of the rotating fan and the vertical movement direction of the lever, respectively, through arrows.

The A/V reception device 200 can display one or more of the images illustrated in FIG. 10a or the images illustrated in FIG. 10b.

Referring to FIG. 10a, the A/V reception device 200 can display a guide image including a first device image 1000 representing the A/V transmission device 100 and a rotation fan image 603 corresponding to the rotation fan 603.

Additionally, the guide image may further include an arrow 1010 that induces clockwise or counterclockwise rotation of the rotation fan 603.

The arrow 1010 may be displayed larger as the panning angle increases, and smaller as the rotation angle decreases.

The user can operate the rotation fan 603 through the guide image.

When the A/V reception device 200 is set in the horizontal direction, the A/V reception device can display an indicator 1030 indicating that the horizontal arrangement of the antenna is complete on the rotation fan image 1003.

Referring to FIG. 10b, the A/V reception device 200 may display a lever image 1051 representing a lever 601a and an arrow 1071 inducing movement of the lever 601a in an upward direction.

The arrow 1071 may be displayed larger as the tilt angle increases, and smaller as the tilt angle decreases.

When the antenna arrangement setting is completed according to the user's lever operation, the A/V reception device 200 can display an indicator 1073 indicating that the vertical arrangement of the antenna is completed.

In this way, according to the embodiment of the present disclosure, a user can perform antenna arrangement settings more conveniently and intuitively through a guide image that guides the arrangement of the antenna.

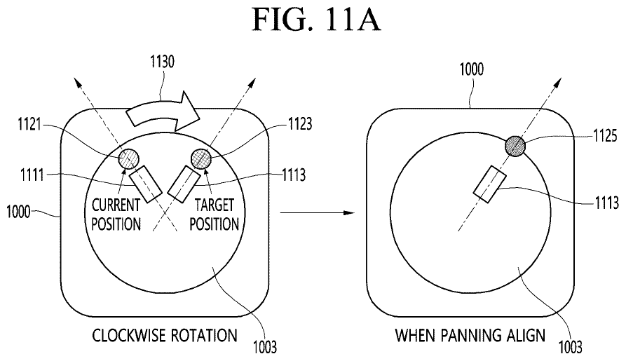

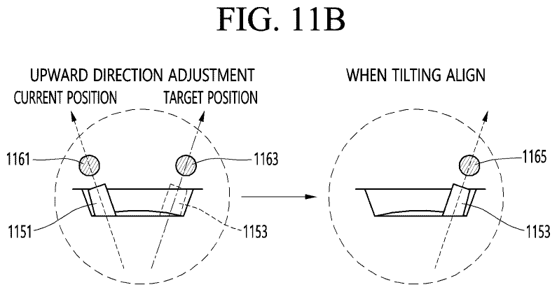

FIGS. 11a and 11b are views explaining examples of guiding the positions of the horizontal rotation direction of the rotation fan and the vertical movement direction of the lever, respectively.

The A/V reception device 200 can display one or more of the images illustrated in FIG. 11a or the images illustrated in FIG. 11b.

The guide image to be described below can be generated based on a control signal received from an A/V transmission device 100. The guide image can be generated by the A/V transmission device 100 or the A/V reception device 200.

Referring to FIG. 11A, the A/V reception device 100 can display a guide image including a device image (1000) representing the A/V transmission device 100, a rotation fan image 1003 corresponding to the rotation fan 603, a first lever upper image 1111 representing the lever accommodation part 601 before movement of the rotation fan 603, a current position indicator 1121 representing the current position of the rotation fan 603, a target position indicator 1123 representing the target position of the rotation fan 603, and a second lever upper image 1113 representing a state where the rotation fan 603 has moved to the target position.

The guide image may further include an arrow 1130 that guides the rotation direction of the rotation fan 603. The position of the lever 601a may change according to the rotation of the rotation fan 603.

Accordingly, the upper image of the lever indicating the position of the lever can also be moved.

The A/V reception device 200 can display a completion indicator 1125 indicating that the horizontal arrangement of the antenna is complete when the arrangement of the antenna is completed (panning align completion) by operating the rotation fan 603.

The current position indicator 1121, the target position indicator 1123 indicating the target position of the rotation fan 603, and the completion indicator 1125 may be displayed in different colors to help improve the user's intuitiveness.

Referring to FIG. 11b, the A/V reception device 100 can display a guide image including a pre-movement lever image 1151 indicating the front surface of the lever 601a before moving, a current position indicator 1161 indicating the current position of the lever 601a, a post-movement lever image 1153 indicating a state where the lever 601a has moved to a target position, and a target position indicator 1163 indicating the target position of the lever 601a.

The A/V reception device 200 can display a completion indicator 1165 indicating that the vertical alignment of the antenna is complete when the antenna is aligned (tilting align complete) by operating the lever 601a.

The current position indicator 1161 indicating the current position of the lever 601a, the target position indicator 1163 indicating the target position of the lever 601a, and the completion indicator 1165 are each displayed in different colors to help the user's intuitiveness.

The A/V reception device 200 receives the current angle of the rotation fan 603 and the current angle of the lever 601a from the A/V transmission device 100, and can reflect the position of the rotation fan and the position of the lever in real time on the guide image through an indicator according to the received angle.

To this end, the A/V transmission device 100 may be equipped with an angle sensor that measures the rotation angle of the rotation fan 603 and an angle sensor that measures the movement angle of the lever 601a.

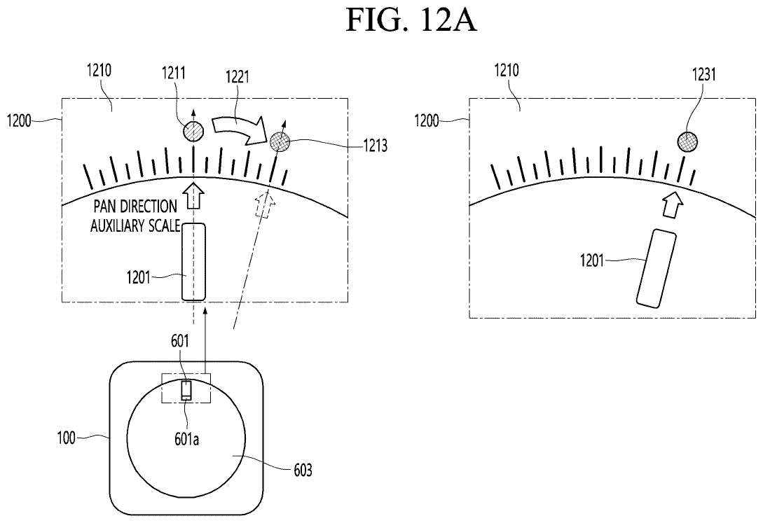

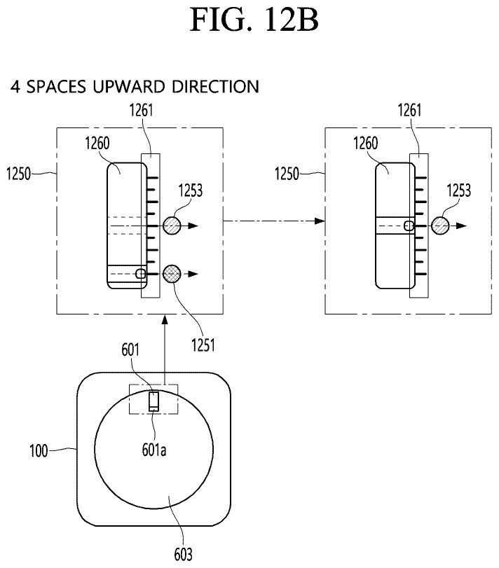

FIGS. 12a and 12b are views explaining another example of guiding the positions of the horizontal rotation direction of the rotation fan and the vertical movement direction of the lever, respectively.

The A/V reception device 200 can display one or more of the images illustrated in FIG. 11a or the images illustrated in FIG. 11b.

The guide image to be described below can be generated based on a control signal received from an A/V transmission device 100. The guide image can be generated by the A/V transmission device 100 or the A/V reception device 200.

Referring to FIG. 12a, a first enlarged guide image 1200 is illustrated that enlarges the area where the lever 601a of the A/V transmission device 100 is located, when viewed from above.

The first enlarged guide image 1200 may include a lever image 1201 illustrating the upper side of the lever 601a, a scale image 1210 guiding the fine movement of the rotation fan 603, a current position indicator 1211 illustrating the current position of the antenna in the horizontal direction, a target position indicator 1213 illustrating the target position of the antenna in the horizontal direction, and an arrow 1221 guiding the movement of the rotation fan 603.

The A/V reception device 200 can display a completion indicator 1231 indicating that the horizontal alignment of the antenna is complete when the horizontal alignment of the antenna is complete (panning align complete) by operating the rotation fan 603.

The color of the indicator may be displayed as yellow when there is less than 15 degrees left from the current position of the rotation fan 603 to the target position, and as orange when there is more than 15 degrees left to the target position. When the rotation fan 603 has been moved to the target position, the color of the indicator may be displayed as green.

Referring to FIG. 12b, a second enlarged guide image 1250 is illustrated that enlarges the area where the lever 601a of the A/V transmission device 100 is located, when viewed from the front surface.

The second enlarged guide image 1250 may include a front lever image 1260 illustrating a front view of the lever 601a, a scale image 1261 guiding fine movement of the lever 601a, a current position indicator 1251 illustrating a current position of the lever 601a, and a target position indicator 1253 illustrating a target position of the lever 601a.

The A/V reception device 200 can display a completion indicator 1253 indicating that the vertical alignment of the antenna is complete when the vertical alignment of the antenna is completed (tilting align completion) by the operation of moving the lever 601a upward.

The color of the indicator may be displayed as yellow when there is less than 15 degrees left from the current position of the lever 601a to the target position, and as orange when there is more than 15 degrees left to the target position. When the lever 601a is moved to the target position, the color of the indicator may be displayed as green.

In this way, according to the embodiment of the present disclosure, the user can be guided to the optimal arrangement of the sending antennas by providing information for the fine operation of the rotation fan 603 and the lever 601a.

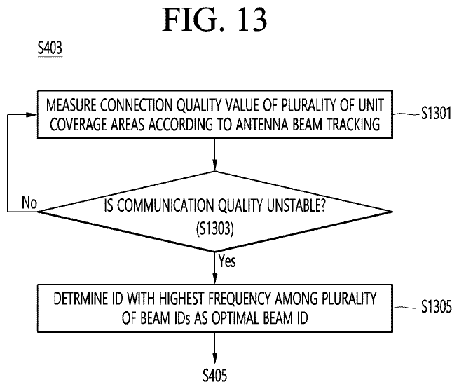

FIG. 13 is a view explaining the process of selecting an optimal beam ID when the communication quality between an A/V transmission device and an AV reception device is unstable.

The embodiment of FIG. 13 may be a view that embodies S403 of FIG. 4.

The processor 190 of the A/V transmission device 100 measures connection quality values of a plurality of unit coverage areas according to antenna beam tracking (S1301).

The processor 190 can radiate an antenna beam through each of a plurality of unit coverage areas included in the first antenna beam book 500 and measure a connection quality value corresponding to each unit coverage area based on the radiated beam.

The processor 190 of the A/V transmission device 100 determines whether the communication quality is unstable based on the measured connection quality values (S1303).

The processor 190 may determine that the state of the communication quality between the A/V transmission device 100 and the A/V reception device 200 is unstable if each of the plurality of connection quality values is less than a preset quality value. The state of the communication quality may include a normal state and an unstable state.

When the processor 190 of the A/V transmission device 100 determines that the communication quality is unstable, the processor determines the ID with the highest frequency among multiple beam IDs as the optimal beam ID (S1305).

The processor 190 can measure the connection quality value a preset number of times for each unit coverage area. Each connection quality value can be less than the preset quality.

The processor 190 can measure the number of times the measured connection quality value for each unit coverage area is greater than 0.

The processor 190 can determine the beam ID of the unit coverage area corresponding to the largest number of times the measured connection quality value is greater than 0 as the optimal beam ID.

However, in this case, image transmission between the A/V transmission device 100 and the A/V reception device 200 may not be smooth. The A/V transmission device 100 can transmit information about the horizontal correction angle and information about the vertical correction angle of the sending antennas to the A/V reception device 200 through the transmission interface 160.

The A/V reception device 200 may store a plurality of guide images (for example, FIGS. 10a to 12b) that guide a horizontal angle correction method and a vertical angle correction method in the memory 250.

The A/V reception device 200 can determine a guide image for guiding antenna arrangement based on information about horizontal correction angles and information about vertical correction angles of sending antennas, and can display the determined guide image on a display 260.

In another embodiment, the A/V transmission device 200 may store a plurality of guide images (for example, FIGS. 10a to 12b) that guide a horizontal angle correction method and a vertical angle correction method in the memory 140.

The A/V transmission device 200 can determine a guide image for guiding antenna arrangement based on information about horizontal correction angles and information about vertical correction angles of sending antennas, and can transmit the determined guide image to the A/V reception device 200 through a wireless communication interface 120.

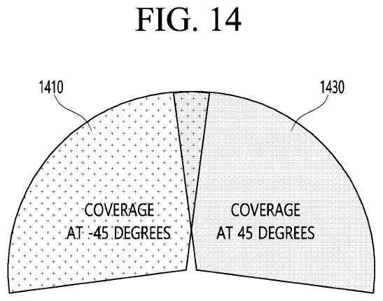

FIG. 14 is a view illustrating a guide image provided when no valid link is found according to an embodiment of the present disclosure.

In FIG. 14, it is assumed that the setting range of the horizontal angle of the antenna is −90 to 90 degrees.

The A/V transmission device 100 or the A/V reception device 200 may determine that no valid link exists if all measured connection quality values for each unit coverage area are less than a preset quality value.

A valid link may exist when there is a unit coverage area whose connection quality value is equal to or greater than a preset quality value.

The A/V reception device 200 can display a first coverage image 1410 or a second coverage image 1430 with a reduced horizontal angular range built into the memory 250.

The first coverage image 1410 may be a guiding image that induces the setting of the horizontal angle range of the antenna to −45 degrees to 0 degrees.

The second coverage image 1430 may be a guiding image that induces the horizontal angle of the antenna to be set to a range of 0 to 45 degrees.

The user can operate the horizontal angle via the rotation fan 603, and once a valid link is found, a precise antenna pointing operation can follow.

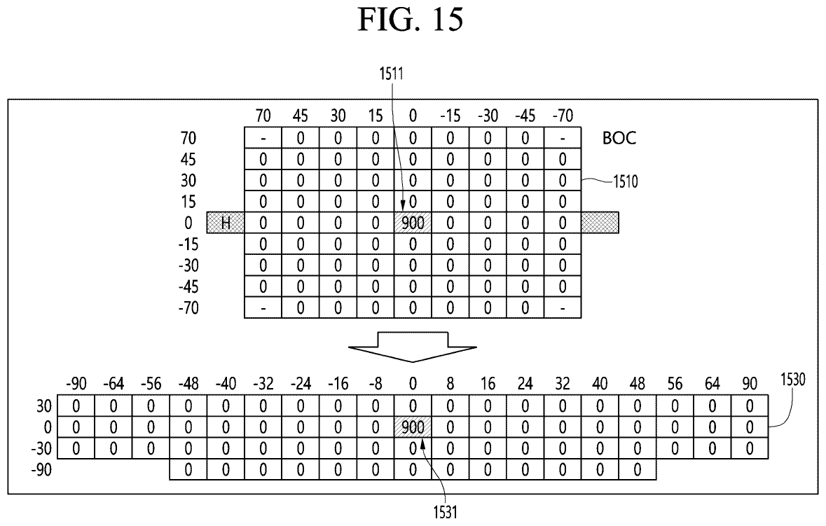

FIG. 15 is a drawing illustrating a sending antenna beam book and a reception antenna beam book according to an embodiment of the present disclosure.

Referring to FIG. 15, a sending antenna beam book 1510 that divides the entire coverage area of sending antennas into a plurality of unit coverage areas and a reception antenna beam book 1530 that divides the entire coverage area of reception antennas into a plurality of unit coverage areas are illustrated.

The target beam ID of the sending antenna beam book 1510 can be assigned to the unit coverage area 1511 located most centrally among the multiple unit coverage areas.

The unit coverage area 1511 may be an area that reflects the optimal performance of the sending antennas. Elements for determining the performance of the antenna may include one or more of the antenna gain and phase error.

The target beam ID of the reception antenna beam book 1530 can be assigned to a unit coverage area 1531 located at the center among a plurality of unit coverage areas.

The unit coverage area 1531 may be an area that reflects the optimal performance of the reception antennas. Elements for determining the performance of the antenna may include one or more of the antenna gain and phase error.

According to one embodiment of the present disclosure, the above-described method can be implemented as a processor-readable code on a medium in which a program is recorded. Examples of the processor-readable medium include a ROM, a RAM, a CD-ROM, a magnetic tape, a floppy disk, an optical data storage device, or the like.

The display device described above is not limited to the configuration and method of the embodiments described above, and the embodiments may be configured by selectively combining all or part of the embodiments so that various modifications can be made.

1. A wireless transmission device, comprising:
a compression chip compressing video data;
an RF (Radio Frequency) transmission interface including a plurality of sending antennas and transmitting the compressed video data to a wireless reception device; and
a processor provided in the entire coverage area of the RF transmission interface, measuring a plurality of connection quality values corresponding to each of a plurality of unit coverage areas identified through a beam identifier, obtaining a first optimal beam identifier (ID) as a beam identifier of a unit coverage area having a highest quality value among the plurality of unit coverage areas based on the measured plurality of connection quality values, determining whether the obtained first optimal beam ID is identical to a preset first target beam ID, and if it is determined that the first optimal beam ID is not identical to the preset first target beam ID, generating a first antenna pointing correction guide for pointing correction of the plurality of sending antennas,
wherein the processor compares a horizontal angle of the first optimal beam ID with a horizontal angle of the first target beam ID, generates first horizontal correction information including a horizontal correction angle and a rotation direction of the horizontal correction angle according to the comparison result, compares a vertical angle of the first optimal beam ID with a vertical angle of the first target beam ID, and generates first vertical correction information including a vertical correction angle and a tilting direction of the vertical correction angle according to the comparison result,
wherein the processor transmits the first antenna pointing correction guide including the first horizontal correction information and the first vertical correction information to the wireless reception device,
a box comprising the compression chip, the RF (Radio Frequency) transmission interface and the processor,
a rotation fan controlling the horizontal rotation direction of the RF transmission interface,
a lever controlling the vertical direction of the RF transmission interface, and
a lever accommodation part for accommodating the lever.

2-4. (canceled)

5. The wireless transmission device of-claim claim 1,
wherein the processor receives a pointing correction input through the rotation fan and the lever.

6. The wireless transmission device of claim 5,
wherein the processor, if determining that the first optimal beam ID is the same as the preset first target beam ID, measures a plurality of connection quality values corresponding to each of a plurality of sub-areas included in the unit coverage area corresponding to the first optimal beam ID, obtains a second optimal beam identifier (ID) as a beam identifier of the unit coverage area having the largest quality value among the plurality of sub-areas based on the measured plurality of connection quality values, determines whether the obtained second optimal beam ID is the same as the preset second target beam ID, and if determining that the second optimal beam ID is not the same as the preset second target beam ID, generates a second antenna pointing correction guide for pointing correction of the plurality of sending antennas.

7. The wireless transmission device of claim 6,
wherein the processor compares a horizontal angle of the second optimal beam ID with a horizontal angle of the second target beam ID, generates second horizontal correction information including a horizontal correction angle and a rotation direction of the horizontal correction angle according to the comparison result, compares a vertical angle of the second optimal beam ID with a vertical angle of the second target beam ID, and generates second vertical correction information including a vertical correction angle and a tilting direction of the vertical correction angle according to the comparison result.

8. The wireless transmission device of claim 7,
wherein the processor transmits the second antenna pointing correction guide including the second horizontal correction information and the second vertical correction information to the wireless reception device.

9. The wireless transmission device of claim 6, further comprising:
a memory storing a first antenna beam book including information distinguishing each of the plurality of unit coverage areas included in the entire coverage area of the beam radiated through the plurality of sending antennas by a beam identifier,
wherein an angle in a horizontal direction and an angle in a vertical direction correspond to each other in each unit coverage area.

10. The wireless transmission device of claim 9,
wherein the memory further stores a second antenna beam book including information distinguishing each of the plurality of sub-areas included in the unit coverage area by a beam identifier, and
wherein an angle in a horizontal direction and an angle in a vertical direction correspond to each other in each sub-area.

11. A wireless display system comprising:
a plurality of sending antennas; and
a wireless transmission device transmitting the compressed video data to a wireless reception device and a wireless reception device receiving the compressed video data, restoring the received video data, and displaying the restored video data,
wherein the wireless transmission device is provided in the entire coverage area of the plurality of sending antennas, measures a plurality of connection quality values corresponding to each of a plurality of unit coverage areas identified through a beam identifier, obtains a first optimal beam identifier (ID) as a beam identifier of a unit coverage area having a highest quality value among the plurality of unit coverage areas based on the measured plurality of connection quality values, determines whether the obtained first optimal beam ID is the same as a preset first target beam ID, and, if determining that the first optimal beam ID is not the same as the preset first target beam ID, generates a first antenna pointing correction guide for pointing correction of the plurality of sending antennas,
wherein the wireless transmission device compares a horizontal angle of the first optimal beam ID with a horizontal angle of the first target beam ID, generates first horizontal correction information including a horizontal correction angle and a rotation direction of the horizontal correction angle according to the comparison result, compares a vertical angle of the first optimal beam ID with a vertical angle of the first target beam ID, and generates first vertical correction information including a vertical correction angle and a tilting direction of the vertical correction angle according to the comparison result, and transmits the first antenna pointing correction guide including the first horizontal correction information and the first vertical correction information to the wireless reception device, and
wherein the wireless reception device displays a guide image based on the first antenna pointing correction guide, and
wherein the guide image includes at least one of an image for adjusting a horizontal rotation direction of the plurality of sending antennas or an image for adjusting a tilting direction of the plurality of sending antennas,
a box comprising the compression chip, the RF (Radio Frequency) transmission interface and the processor,
a rotation fan controlling the horizontal rotation direction of the RF transmission interface,
a lever controlling the vertical direction of the RF transmission interface, and
a lever accommodation part for accommodating the lever,
wherein the wireless transmission device comprising
a box,
a rotation fan controlling the horizontal rotation direction of the RF transmission interface,
a lever controlling the vertical direction of the RF transmission interface, and
a lever accommodation part for accommodating the lever,
wherein the wireless transmission device includes a rotation fan controlling the horizontal rotation direction of the plurality of sending antennas; and a lever controlling the tilting direction of the plurality of sending antennas, and receives a pointing correction input through the rotation fan and the lever, and
wherein the wireless reception device displays a manipulation result according to the pointing correction input.

12-13. (canceled)

14. The wireless display system of claim 11,
wherein the wireless transmission device, if determining that the first optimal beam ID is the same as the preset first target beam ID, measures a plurality of connection quality values corresponding to each of a plurality of sub-areas included in the unit coverage area corresponding to the first optimal beam ID, obtains a second optimal beam identifier (ID) as a beam identifier of the unit coverage area having the largest quality value among the plurality of sub-areas based on the measured plurality of connection quality values, determines whether the obtained second optimal beam ID is the same as the preset second target beam ID, and if determining that the second optimal beam ID is not the same as the preset second target beam ID, generates a second antenna pointing correction guide for pointing correction of the plurality of sending antennas.

15. The wireless display system of claim 14,
wherein the wireless transmission device compares a horizontal angle of the second optimal beam ID with a horizontal angle of the second target beam ID, generates second horizontal correction information including a horizontal correction angle and a rotation direction of the horizontal correction angle according to the comparison result, compares a vertical angle of the second optimal beam ID with a vertical angle of the second target beam ID, generates second vertical correction information including a vertical correction angle and a tilting direction of the vertical correction angle according to the comparison result, and transmits the second antenna pointing correction guide including the second horizontal correction information and the second vertical correction information to the wireless reception device.
